(19) United States
(12) Patent Application Publication
(10) Pub. No.: US 2011/0313076 A1
(43) Pub. Date: Dec. 22, 2011

(54) GASKET-FORMING MATERIAL FOR HARD DISK AND GASKET FOR HARD DISK USING THE SAME

(75) Inventor: Toshihiko Kurata, Kanagawa (JP)

(73) Assignee: Bridgestone Corporation, Chuo-ku, Tokyo (JP)

(21) Appl. No.: 12/672,364

(22) PCT Filed: Aug. 5, 2008
(86) PCT No.: PCT/JP2008/064002

§ 371 Date: Mar. 10, 2010

(30) Foreign Application Priority Data
Aug. 6, 2007 (JP) 2007-203977

(51) Int. Cl. C08F 2/46; C08F 220/10; C08K 5/103; C08F 226/00; C08F 2/44

(52) U.S. Cl. 522/96; 526/301; 524/850; 524/766

(57) ABSTRACT

Provided are a gasket-forming material for a hard disk device providing a gasket which can improve a reworking property of a cover plate and a base plate in a hard disk device and a gasket prepared by using the above material.

They are a gasket-forming material for a hard disk device comprising (A) an energy ray-curable urethane liquid oligomer having a polymerizable unsaturated group and (B) a monofunctional (meth)acryl base monomer providing a cured matter having a glass transition temperature (Tg) of −70 to 20° C. and a gasket for a hard disk device comprising a cured matter prepared by curing the above material by irradiating with an energy ray.

### BACKGROUND OF THE INVENTION

The present invention relates to a gasket-forming material for a hard disk device and a gasket for a hard disk device prepared by using the same. More specifically, it relates to a gasket-forming material for a hard disk device which provides a gasket improved in a reworking property of a cover plate and a base plate in a hard disk device and a gasket for hard disk device having the above characteristic which is prepared by using the above gasket-forming material for a hard disk device.

### RELATED ART

In recent years, an increase in performances and a reduction in a size are accelerated in a HDD (hard disk device) of a computer, and complicated circuits are constituted therein, so that troubles are brought about even by a small amount of dusts. Accordingly, requirement for preventing dusts is growing high in terms of practical use, and it is usually carried out to prevent dusts from coming in by using a gasket.

A method in which a gasket is molded by injecting a thermoplastic elastomer and a method in which a gasket is formed by punching a sheet comprising EPDM (ethylene propylene diene rubber) and fluorocarbon rubber into prescribed forms and in which they are adhered have so far been employed as a method for producing a gasket of HDD.

On the other hand, a method in which a gasket is produced by coating an optically curable composition for a sealing material on an adherend by means of a dispenser, molding it and then curing primarily by a UV ray has come to be employed in recent years in order to reduce investment to the facilities and the processing cost (refer to, for example, patent documents 1 to 4). In order to obtain a sufficiently high sealing property of the gasket, a urethane acrylate oligomer having a high molecular weight is used as a principal component for the above optically curable composition for a sealing material so that a cured matter thereof is provided with a low hardness.
Patent document 1: WO 96/10594
Patent document 2: Japanese Patent Application Laid-Open No. 7047/2003
Patent document 3: Japanese Patent Application Laid-Open No. 26919/2004
Patent document 4: Japanese Patent Application Laid-Open No. 298964/2006

### DISCLOSURE OF THE INVENTION

HDD is protected, as shown in FIG. 1, by a protector 1 comprising a cover plate 11 and a base plate 12. To be more specific, HDD is provided on the base plate 12 and sealed by interposing the gasket 13 between the cover plate 11 and the base plate 12.

On the other hand, an existing production yield of HDD is about 50%, and the defective products are required, as shown in FIG. 2 or FIG. 3, to detach the cover plate 11 from the base plate 12 to adjust the parts. The gasket includes a case in which it is formed, as shown in FIG. 2, by being adhered on the cover plate 11 and a case in which it is formed, as shown in FIG. 3, by being adhered on the base plate 12. In both cases, the gasket is sealed by being pressed to the other plate and usually stuck on the above other plate. In adjusting the parts of HDD, it is desired that when detaching the cover plate 11 from the base plate 12, the gasket is cleanly separated from the stuck part without remaining thereon and that the gasket is maintained as it is on the adhered part. Having the above characteristic makes it possible to provide the so-called reworking property that the cover plate 11 and the base plate 12 can be reused. However, descriptions on the reworking property are not found in the prior art documents described above.

In light of the situations described above, an object of the present invention is to provide a gasket-forming material for a hard disk device which provides a gasket capable of improving a reworking property of a cover plate and a base plate in a hard disk device and a gasket for hard disk device having the characteristic described above which is prepared by using the above gasket-forming material for a hard disk device.

In the above case, adhesion means that a matter is firmly adhered on an adherend by a chemical bond and the like by curing by irradiating with a UV ray, and tackiness means that a matter is physically adhered on an adherend by a tack of a gasket, heat and compression.

The present inventors repeated intensive researches in order to achieve the object described above and paid attentions to the point that it is important for improving a reworking property of a cover plate and a base plate in a hard disk device that when a gasket provided between the cover plate and the base plate is adhered to the cover plate, an adhesive property thereof with the cover plate is enhanced and that a tacky property thereof with the base plate is reduced in a range in which a sealing property is not damaged or that when the gasket is adhered to the base plate, an adhesive property thereof with the base plate is enhanced and that a tacky property thereof with the cover plate is reduced in a range in which a sealing property is not damaged.

Researches further repeated by the present inventors based on the above point to which attentions have been paid have resulted in finding that a gasket obtained by coating a material comprising an energy ray-curable urethane liquid oligomer having a polymerizable unsaturated group and a monofunctional (meth)acryl base monomer which provides a cured matter having a glass transition temperature falling in a prescribed range on a cover plate in a hard disk device and irradiating it with an energy ray has a larger contact area with the above cover plate as compared with a contact area with the base plate and that an adhesive property with the cover plate grows higher as compared with a tacky property with the base plate because the uncured material is cured in a state in which it is brought into contact with the cover plate.

Further, in the above gasket, a compressed surface pressure of a contact part with the base plate is low (a 20% compressed surface pressure is usually 4N or less), and the tack is small. Accordingly, it has been found that the cover plate can readily be detached from the base plate without causing breaking and peeling of the gasket.

On the other hand, it has been found that when the material of the present invention is applied to the base plate, an adhesive property with the base plate grows higher as compared with a tacky property with the cover plate; a compressed surface pressure of a contact part with the cover plate is low, and the tack is reduced; the cover plate can readily be detached, as is the case with described above, from the base plate without causing breaking and peeling of the gasket.

The present invention has been completed based on the above knowledge.

That is, the present invention provides the following inventions.
(1). A gasket-forming material for a hard disk device comprising (A) an energy ray-curable urethane liquid oligomer having a polymerizable unsaturated group and (B) a monofunctional (meth)acryl base monomer providing a cured matter having a glass transition temperature (Tg) of −70 to 20° C.
(2). The gasket-forming material for a hard disk device according to the above item (1), wherein the energy ray-curable urethane liquid oligomer (A) having a polymerizable unsaturated group is an unsaturated group-containing urethane oligomer represented by the following Formula (I):

R¹—O—CONH—R²—NHCO—(—O—R³—O—CONH—R²—NHCO)ₚ-(-A-CONH—R²—NHCO—)_{q}—(—O—R³—O—CONH—R²—NHCO—)ᵣ—O—R¹ (I)

(wherein R¹ is a hydroxyl group-removed residue of a monool compound containing at least any unsaturated group of a (meth)acryloyl group and a vinyl group; R² is an isocyanate-removed residue of an organic diisocyanate compound; R³ is a hydroxyl group-removed residue of a polyesterdiol compound having a number average molecular weight of 1×10³ to 1×10⁴ and containing a cyclic group or a branched chain group; A is a dehydrogenated residue of a diamine compound or a dehydrogenated residue of a diol compound; each of p and r is 0 to 7, and q is 0 to 3, provided that when q is 0, 1<<p+r<<10) and having a number average molecular weight of 5×10³ to 5×10⁴.
(3). The gasket-forming material for a hard disk device according to the above item (2), wherein R³ in Formula (1) is a hydroxyl group-removed residue of a polyesterdiol compound obtained by condensing cyclic group-containing dicarboxylic acid with diol or a hydroxyl group-removed residue of a polyester diol compound modified by reacting cyclic group-containing dicarboxylic anhydride with dial.
(4). The gasket-forming material for a hard disk device according to the above item (2), wherein R¹ in Formula (I) is a hydroxyl group-removed residue of a monool compound of any of hydroxyalkyl(meth)acrylate and hydroxyalkyl vinyl ether.
(5). The gasket-forming material for a hard disk device according to any of the above items (2) to (4), wherein the unsaturated group-containing urethane oligomer (a case in which q is 0 in Formula (I)) is obtained by subjecting a polyesterdiol compound and an organic diisocyanate compound to polyaddition reaction to form an addition product having isocyanate groups at both ends and then adding monool compounds to the above isocyanate groups.
(6). The gasket-forming material for a hard disk device according to any of the above items (2) to (4), wherein the unsaturated group-containing urethane oligomer (a case in which q is not 0 in Formula (I)) is obtained by subjecting a polyesterdiol compound and an organic diisocyanate compound to polyaddition reaction to form an addition product having isocyanate groups at both ends and then adding each end of a diamine compound or a diol compound to an isocyanate group of the above addition product at one end and adding a monool compound to an isocyanate group of the above addition product at the other one end.
(7). The gasket-forming material for a hard disk device according to any of the above items (1) to (6), wherein the monofunctional (meth)acryl base monomer (B) providing a cured matter having a glass transition temperature (Tg) of −70 to 20° C. is a (meth)acrylic ester compound represented by Formula (II):

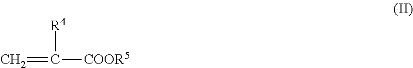

(wherein R⁴ represents a hydrogen atom or methyl, and R⁵ represents an alkyl group having 8 to 20 carbon atoms). (8). The gasket-forming material for a hard disk device according to any of the above items (1) to (6), wherein the monofunctional (meth)acryl base monomer (B) providing a cured matter having a glass transition temperature (Tg) of −70 to 20° C. is a (meth)acrylic ester compound represented by Formula (III):

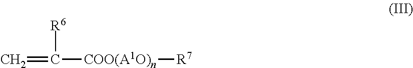

(wherein A¹ represents an alkylene group having 2 to 4 carbon atoms; R⁶ represents a hydrogen atom or methyl; R⁷ represents an alkyl group having 6 to 20 carbon atoms, an aralkyl group having 7 to 20 carbon atoms or an aryl group having 6 to 20 carbon atoms; and n represents 1 to 7 on an average).
(9). The gasket-forming material for a hard disk device according to any of the above items (1) to (8), comprising 5 to 40 parts by mass of the component (B) based on 100 parts by mass of the component (A).
(10). The gasket-forming material for a hard disk device according to any of the above items (1) to (9), further comprising 0.5 to 10 parts by mass of (C) a thixotropicity-providing agent based on 100 parts by mass of the component (A).
(11). The gasket-forming material for a hard disk device according to the above item (10), wherein the component (C) is an organic thickener.
(12). The gasket-forming material for a hard disk device according to the above item (11), wherein the organic thickener is hydrogenated castor oil.
(13). The gasket-forming material for a hard disk device according to any of the above items (1) to (12), further comprising at least one of a polymerization initiator and a cross-linking agent as a component (D).
(14). A gasket for a hard disk device comprising a cured matter prepared by curing the gasket-forming material according to any of the above items (1) to (13) by irradiating with an energy ray.

According to the present invention, use of the gasket-forming material comprising the energy ray-curable urethane liquid oligomer and the low Tg monofunctional (meth)acryl base monomer which provides a cured matter having a glass transition temperature falling in a certain range makes it possible to enhance an adhesive property with a cover plate and control a tacky property with a base plate to a lower level when the above gasket material is applied to the cover plate and makes it possible to enhance an adhesive property with the base plate and control a tacky property with the cover plate to a lower level when the above gasket material is applied to the base plate. Accordingly, a reworking property of the above cover plate and the base plate can be improved. Further, according to the present invention, a gasket for hard disk device which can improve a reworking property of the cover plate and the base plate can be provided.

### BRIEF DESCRIPTIONS OF THE DRAWINGS

FIG. 1 is a conceptual drawing showing a protector for protecting HDD.

FIG. 2 is a drawing in which a cover plate of the protector for protecting HDD is detached from a base plate and shows a case in which a gasket is adhered to the cover plate.

FIG. 3 is a drawing in which the cover plate of the protector for protecting HDD is detached from the base plate and shows a case in which the gasket is adhered to the base plate.

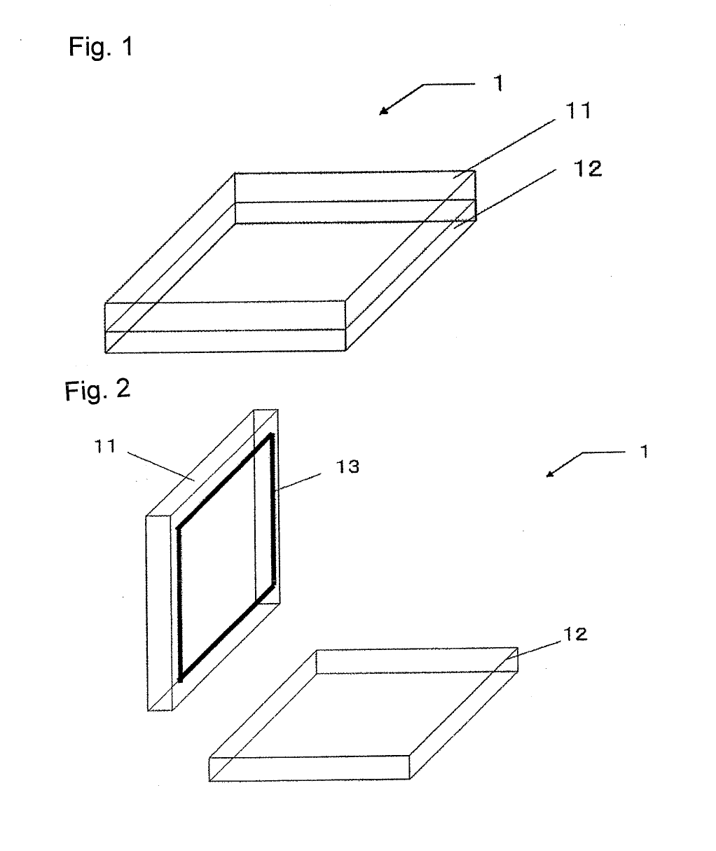

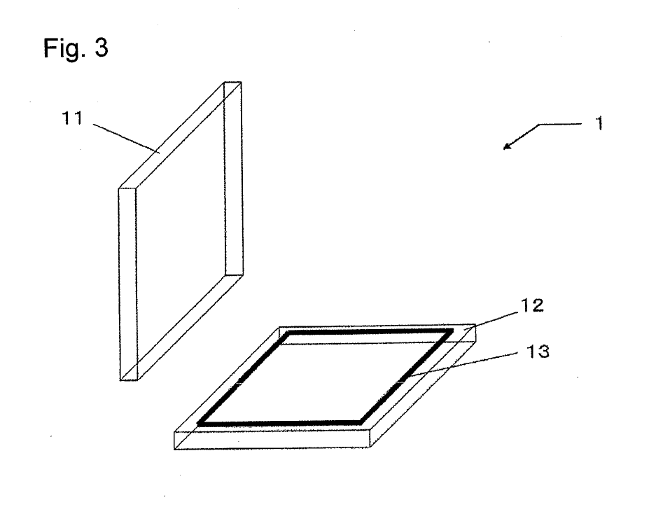

### EXPLANATIONS OF THE CODES

1 Protector
11 Cover plate
12 Base plate
13 Gasket

### BEST MODE FOR CARRYING OUT THE INVENTION

The gasket-forming material of the present invention for a hard disk device (hereinafter referred to merely as the gasket-forming material) is characterized by comprising the energy ray-curable urethane liquid oligomer (A) having a polymerizable unsaturated group and the monofunctional (meth)acryl base monomer (B) providing a cured matter having a glass transition temperature (Tg) of −70 to 20° C.

### Energy Ray-Curable Urethane Liquid Oligomer (A):

In the gasket-forming material of the present invention, the energy ray-curable urethane liquid oligomer used as the component (A) shows a urethane liquid oligomer which is cross-linked by irradiating with a ray having an energy quantum among electromagnetic waves or charged particle beams, that is, a UV ray, an α ray, a β ray, a γ ray, an electron beam and the like.

An unsaturated group-containing urethane oligomer having a structure represented by the following Formula (I):

R¹—O—CONH—R²—NHCO—(—O—R³—O—CONH—R²—NHCO)ₚ-(-A-CONH—R²—NHCO—)_{q}—(—O—R³—O—CONH—R²—NHCO—)ᵣ—O—R¹ (I)

and having a number average molecular weight of 5×10³ to 5×10⁴ can be used as the energy ray-curable urethane liquid oligomer of the above component (A).

In Formula (I), R¹ is a hydroxyl group-removed residue of a monool compound containing at least any unsaturated group of a (meth)acryloyl group and a vinyl group.

The monool compound includes preferably hydroxyalkyl(meth)acrylates and hydroxyalkyl vinyls and includes, for example, diethylene glycol mono(meth)acrylate, dipropylene glycol mono(meth)acrylate, tripropylene glycol mono(meth)acrylate, triethylene glycol mono(meth)acrylate, polyethylene glycol mono(meth)acrylate and the like. A (meth)acryloyl group means an acryloyl group or a methacryloyl group.

R² is an isocyanate-removed residue of an organic diisocyanate compound. It includes, for example, an alkylene group such as methylene group, ethylene group, propylene group, butylene group, hexamethylene group and the like, a cycloalkylene group such as cyclohexylene group and the like, an arylene group such as phenylene group, tolylene group, naphthylene group and the like and xylylene group. In this connection, the alkyl group may be any of a linear form, a branched form and a cyclic form. The organic diisocyanate compound includes preferably isophoronediisocyanate, hexamethlenediisocyanate, norbornanediisocyanate, tolylenediisocyanate, xylylenediisocyanate, trimethylhexamethlenediisocyanate, naphthalenediisocyanate, hydrogenated xylylenediisocyanate, hydrogenated diphenylmethanediisocyanate, diphenylmethanediisocyanate and the like.

R³ is a hydroxyl group-removed residue of a polyesterdiol compound having a number average molecular weight of 1×10³ to 1×10⁴ and containing a cyclic group or a branched chain group.

Among them, R³ is preferably a hydroxyl group-removed residue of the polyesterdiol compound described above which is obtained by condensing cyclic group-containing dicarboxylic acid with diol or a hydroxyl group-removed residue of the polyesterdiol compound modified by reacting cyclic group-containing dicarboxylic anhydride with diol.

The cyclic group-containing dicarboxylic acid or the acid anhydride thereof constituting R³ includes, for example, phthalic acid, phthalic anhydride, pyromellitic acid, pyromellitic anhydride, isophthalic acid, trimellitic acid, trimellitic anhydride, tetrahydrophthalic acid, tetrahydrophthalic anhydride, hexahydrophthalic acid, hexahydrophthalic anhydride and the like. They may be used in a mixture of plural kinds thereof.

The diol constituting R³ includes, for example, ethylene glycol, propylene glycol, 2,2,4-trimethyl-1,3-pentanediol, neopentyl glycol, 1,2-propanediol, 1,3-propanediol, 1,4-propanediol, 1,3-butanediol, 1,5-pentanediol, 1,6-hexanediol, 2,2-dimethyl-1,3-propanediol, bisphenol A, 2,2-thiodiethanol, acetylene type diol, hydroxy-end polybutadiene, 1,4-cyclohexanedimethanol, 1,2-cyclohexanedimethanol, 1,3-cyclohexanedimethanol, 1,4-bis(2-hydroxyethoxy)cyclohexane, trimethylene glycol, tetramethylene glycol, pentamethylene glycol, hexamethylene glycol, decamethylene glycol, diethylene glycol, triethylene glycol, tetraethylene glycol, norbornylene glycol, 1,4-benzenedimethanol, 1,4-benzenediethanol, 2,4-dimethyl-2-ethylenehexane-1,3-diol, 2-butene-1,4-diol, 2,4-diethyl-1,5-pentanediol, 2-ethyl-2-butyl-1,3-propanediol, 3-methyl-1,5-pentanediol and the like.

In Formula (I), A is a dehydrogenated residue of a diamine compound or a dehydrogenated residue of a diol compound.

The above dehydrogenated residue shall not specifically be restricted and is preferably a dehydrogenated residue of a diamine compound selected from, for example, diaminopropane, diaminobutane, nonanediamine, isophoronediamine, hexamethylnediamine, hydrogenated diphenylmethanediamine, bisaminopropyl ether, bisaminopropylethane, bisaminopropyl diethylene glycol ether, bisaminopropyl polyethylene glycol ether, bisaminopropoxyneopentyl glycol, diphenylmethanediamine, xylylenediamine, tolylenediamine and silicone modified by an amino group at both ends and a dehydrogenated residue of a diol compound selected from ethylene glycol, propylene glycol, polyethylene glycol, polypropylene glycol, butylene glycol, polytetramethylene glycol, pentanediol, hexanediol, silicone modified by a hydroxyl group at both ends and carboxyl group-containing diols.

R¹ is preferably a hydroxyl group-removed residue of a monool compound of any of hydroxyalkyl(meth)acrylate and hydroxyalkyl vinyl ether and includes, for example, a hydroxyl group-removed residue of hydroxyethyl acrylate, hydroxymethyl vinyl ether and the like.

The energy ray-curable urethane liquid oligomer of the component (A) can be produced preferably by the following method.

When q is 0 in Formula (1)), the unsaturated group-containing urethane oligomer can be obtained by subjecting the polyesterdiol compound and the organic isocyanate compound each described above to polyaddition reaction to form an addition product having isocyanate groups at both ends and then adding the monool compounds described above to the above isocyanate groups.

Also, when q is not 0 in Formula (I)), the unsaturated group-containing urethane oligomer can be obtained by subjecting the polyesterdiol compound and the organic isocyanate compound each described above to polyaddition reaction to form an addition product having isocyanate groups at both ends and then adding each end of the diamine compound or the diol compound described above to an isocyanate group of the above addition product at one end and adding the monool compound described above to an isocyanate group of the above addition product at the other one end.

When the gasket-forming material of the present invention is irradiated with an energy ray to form a gasket, the above energy ray-curable urethane liquid oligomer exerts an effect of providing the above gasket with a suitable rubber elasticity to enhance a sealing property of the gasket. From the viewpoints of the above effect and the moldability, the above energy ray-curable urethane liquid oligomer has preferably, though depending on a structure thereof, a number average molecular weight of usually 5×10³ to 5×10⁴.

In the present invention, the energy ray-curable urethane liquid oligomer having a polymerizable unsaturated group described above may be used as the component (A) and may be used in combination of two or more kinds thereof.

Monofunctional (meth)acryl Base Monomer (B):

In the present invention, the gasket-forming material is selected so that the gasket which can improve a reworking property of the cover plate and the base plate in the hard disk device is obtained in terms of the key point of the present invention.

Hereinafter, a case in which the gasket is formed on the cover plate shall be explained. In order to improve a reworking property of the cover plate and the base plate described above, it is advisable to strengthen an adhesive property between the cover plate and the gasket in the hard disk device and weaken a tacky property between the base plate and the gasket to make it possible to detach the cover plate without causing breaking and peeling of the gasket. Various methods can be used, as explained later, as a means for enhancing an adhesive property between the cover plate and the gasket. On the other hand, in order to weaken a tacky property between the base plate and the gasket, it is advisable to reduce a compressed surface pressure of the gasket at a part bought into contact with the base plate and decrease the tack, and the present inventors have found that in order to achieve the above matter, it is advisable to lower a cross-linking density and a glass transition temperature of a cured member at a part of the gasket bought into contact with the base plate.

On the other hand, the same shall be applied as well to a case in which the gasket is formed on the base plate, and it is advisable to strengthen an adhesive property between the base plate and the gasket and weaken a tacky property between the cover plate and the gasket to make it possible to detach the cover plate without causing breaking and separating of the gasket.

Also, from the viewpoint of a reworking property of the cover plate and the base plate, it is important that the gasket for a hard disk device has the properties described above and that it is provided with performances as the gasket and a good moldability.

From the above point of view, the monofunctional (meth)acryl base monomer (hereinafter referred to as the low Tg monofunctional (meth)acryl base monomer) providing a homopolymer having a glass transition temperature (Tg) of −70 to 20° C., preferably −70 to 0° C. is used as the component (B) in the gasket-forming material of the present invention.

A glass transition temperature (Tg) of the (meth)acryl base monomer is a value obtained by measuring a polymer obtained by polymerizing the monomer by a conventional radical polymerization method on ordinary conditions by means of a differential scanning colorimeter (DSC).

A compound in which Tg falls in the range described above can suitably be selected as the low Tg monofunctional (meth)acryl base monomer from (meth)acrylic ester compounds represented by Formula (II) and Formula (III):

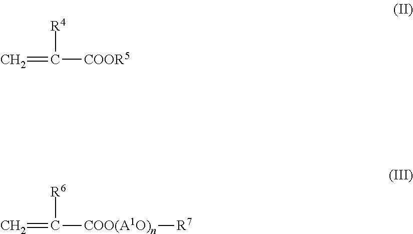

In Formula (II) described above, R⁴ represents a hydrogen atom or methyl, and R⁵ represents a linear or branched alkyl group having 8 to 20 carbon atoms. Various decyl groups, various dodecyl groups, various tetradecyl groups, various hexadecyl groups, various octadecyl groups and the like can be given as the examples of the alkyl group represented by R⁵.

On the other hand, A¹ represents an alkylene group having 2 to 4 carbon atoms in Formula (III) described above. This alkylene group may be any of a linear form and a branched form and includes ethylene group, propylene group, trimethylene group, tetramethylene group, 1-methylpropylene group and the like. Among them, ethylene group and propylene group are preferred, and ethylene group is particularly preferred. R⁶ represents a hydrogen atom or methyl group, and R⁷ represents an alkyl group having 6 to 20 carbon atoms, an aralkyl group having 7 to 20 carbon atoms or an aryl group having 6 to 20 carbon atoms.

Among the groups represented by R⁷, the alkyl group having 6 to 20 carbon atoms may be any of a linear form and a branched form and includes, to be specific, various hexyl groups, various octyl groups, various decyl groups, various dodecyl groups, various tetradecyl groups, various hexadecyl groups, various octadecyl groups and the like. A linear or branched alkyl group having 1 to 15 carbon atoms may be introduced on an aromatic ring in the aralkyl group having 7 to 20 carbon atoms, and it includes, to be specific, a benzyl group, an alkylbenzyl group, a phenethyl group, an alkylphenethyl group, a naphthylmethyl group, an alkylnaphthylmethyl group and the like. Also, a linear or branched alkyl group having 1 to 15 carbon atoms may be introduced on an aromatic ring in the aryl group having 6 to 20 carbon atoms, and it includes, to be specific, a phenyl group, an alkylphenyl group, a naphthyl group, an alkylnaphthyl group and the like.

The term n is a number of 1 to 7 on an average, and if n grows larger, oxygen inhibition is less liable to be brought about in curing. As a result thereof, a tack on the surface is reduced, and a moisture permeability of the cured matter tends to be lowered. The term n is preferably 1 to 4 on an average from the viewpoint of a balance between the tack and the moisture permeability.

In respect to the preferred monomers among the low Tg monofunctional (meth)acryl base monomers of the above component (B), lauryl acrylate (Tg: −3° C.) and isomyristyl acrylate (Tg: −56° C.) can be given as the (meth)acrylic ester compound represented by Formula (II) from the viewpoint of reducing a compressed surface pressure of the cured matter, and compounds represented by the following Formula (III-a) (Tg: 17° C.), Formula (III-b) (Tg: −20° C.), Formula (III-c) (Tg: −22° C.), Formula (III-d) (Tg: −25° C.) and Formula (III-e) (Tg: −18° C.):

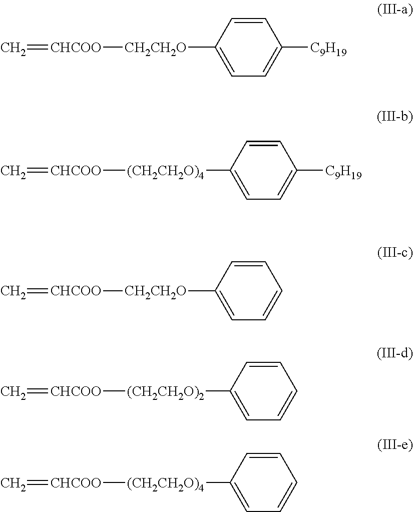

can be given as the (meth)acrylic ester compound represented by Formula (III). Among them, the (meth)acrylic ester compounds represented by Formula (III-a) and (III-d) are particularly suited from the viewpoint of a balance between the compressed surface pressure, the tack and the moisture permeability.

In the present invention, the above low Tg monofunctional (meth)acryl base monomers may be used as the component (B) alone or in combination of two or more kinds thereof.

In the gasket-forming material of the present invention, a content of the low Tg monofunctional (meth)acryl base monomer of the above component (B) is preferably 5 to 40 parts by mass, more preferably 5 to 20 parts by mass based on 100 parts by mass of the energy ray-curable urethane liquid oligomer of the component (A) from the viewpoint that the gasket obtained improves a reworking property of the cover plate and the base plate in the hard disk device and the viewpoint of performances and a moldability of the gasket.

### Thixotropicity-Providing Agent (C):

A thixotropicity-providing agent can further be added as the component (C) to the gasket-forming material of the present invention.

A dispensing method in which a molten resin or a liquid resin is extruded on a cover plate or a base plate in a gasket form by means of a dispenser to integrate them is widely used in an industrial scale as a production process of a gasket for a hard disk device since it has the merit that steps such as a sticking step and the like are not required. A method in which a shearing speed dependency of a viscosity is controlled to a large extent and in which a material having a high viscosity at a low shearing speed and a low viscosity at a high shearing speed is used is employed in order to obtain an accurate gasket form by extrusion. A thixotropicity-providing agent is used in order to control the above shearing speed dependency of a viscosity.

The thixotropicity-providing agent of the component (C) is added preferably in an amount of 0.5 to 10 parts by mass based on 100 parts by mass of the energy ray-curable urethane liquid oligomer of the component (A). Combined use of the above thixotropicity-providing agent makes it possible to enhance effectively the thixotropicity and control the extruded form at a good accuracy to carry out processing. From the above point of view, an addition amount of the component (C) is more preferably 1 to 5 parts by mass. Both of inorganic fillers and organic thickeners can be used as the above thixotropicity-providing agent.

The inorganic filler includes surface-treated fine powder silicas of wet silica and dry silica and natural minerals such as organized bentonite and the like. To be specific, it includes silica fine powders pulverized by a dry method (for example, trade name: Aerosil 300, manufactured by Nippon Aerosil Co., Ltd. and the like), fine powders obtained by modifying the above silica fine powders with trimethyldisilazane (for example, trade name: Aerosil RX 300, manufactured by Nippon Aerosil Co., Ltd. and the like) and fine powders obtained by modifying the silica fine powders described above with dimethylsiloxane (for example, trade name: Aerosil RY 300, manufactured by Nippon Aerosil Co., Ltd. and the like). An average particle diameter of the inorganic filler is preferably 5 to 50 μm, more preferably 5 to 12 μm from the viewpoint of a thickening property.

The organic thickener includes amide waxes, hydrogenated castor oil or mixtures thereof. To be specific, it includes hydrogenated castor oil which is a hydrogenated product of castor oil (a principal component is a nondrying oil of ricinolic acid) (for example, trade name: ADVITROL 100, manufactured by Süd-Chemie Catalysts Japan. Inc., trade name: Disparlon 305, manufactured by Kusumoto Chemicals, Ltd. and the like) and higher amide waxes which are compounds obtained by substituting hydrogen of ammonia with an acyl group (for example, trade name: Disparlon 6500, manufactured by Kusumoto Chemicals, Ltd. and the like).

Among the above thixotropicity-providing agents, the organic thickeners are preferred. Impurities such as heavy metals and the like are unavoidably mixed in the inorganic fillers of natural minerals, and the surface-treated fine powder silicas are changed in a wetting property of a surface and varied in a viscosity of the composition in a certain case. Further, they generate gases harmful to equipments during use in a certain case.

Further, among the organic thickeners, the amide waxes enhance the cross-linking density and increase the hardness in a certain case due to the presence of amine originating in the raw materials, and therefore hydrogenated castor oil is particularly preferred.

### Additive Component (D):

At least one of a photopolymerization initiator and a cross-linking agent can further be added as the component (D) to the gasket-forming material of the present invention. The above addition is particularly preferred when curing is carried out by irradiating with a UV ray.

The photopolymerization initiator may be any of an intermolecular cleavage type and a hydrogen drawing type. The intermolecular cleavage type includes benzoin derivatives, benzyl ketals (for example, trade name: Irgacure 651, manufactured by Ciba Specialty Chemicals K.K.), α-hydroxyacetophenones (for example, trade name: Darocur 1173, Irgacure 184, manufactured by Ciba Specialty Chemicals K.K.), α-aminoacetophenones (for example, trade name: Irgacure 907, Irgacure 369, manufactured by Ciba Specialty Chemicals K.K.), combined use of α-aminoacetophenones and thioxanthones (for example, isopropyithioxanthone, diethylthioxanthone), acylphosphine oxides (for example, trade name: Irgacure 819, manufactured by Ciba Specialty Chemicals K.K.) and the like. The hydrogen drawing type includes combined use of benzophenones and amines and combined use of thioxanthones and amines. The intermolecular cleavage type and the hydrogen drawing type may be used in combination. Among them, α-hydroxyacetophenones which are turned into oligomer and benzophenones which are turned into acrylates are preferred. To be more specific, they include oligo[2-hydroxy-2-methyl-1-[4-(1-methylvinyl)phenyl]propanone] (for example, trade name: ESACURE KIP150, manufactured by Lamberiti S.P.A and the like), benzophenones turned into acrylates (for example, trade name: Ebecryl P136, manufactured by Daicel UCB Ltd. and the like), imide acrylates and the like.

The cross-linking agent includes suitably organic peroxides, and to be specific, it includes, for example, 2,5-dimethyl-2,5-di(t-butylperoxy)-hexane; 2,5-dimethyl-2,5-di(benzoylperoxy)-hexane; t-butylperoxy benzoate; dicumyl peroxide; t-butylcumyl peroxide; diisopropyl benzohydroperoxide; 1,3-bis-(t-butylperoxyisopropyl)-benzene; benzoyl peroxide; 1,1-di(t-butylperoxy)-3,3,5-trimethylcyclohexane and the like.

### Other Optional Additive Components:

Other monomers, for example, (meth)acrylic ester base monomers can suitably be added, if necessary, to the gasket-forming material of the present invention as long as the objects of the present invention are not damaged.

Further, in addition to the thixotropicity-providing agents described above, capable of being blended are scale-like inorganic additives such as clay, diatomaceous earth, talc, barium sulfate, calcium carbonate, magnesium carbonate, metal oxides, mica, graphite, aluminum hydroxide and the like, granular or powdery solid fillers such as various metal powders, glass powders, ceramic powders, granular or powder polymers and the like, other various natural or artificial short fibers and long fibers (for example, glass fibers, metal fibers, other various polymer fibers and the like) and the like.

Further, blended are hollow fillers, for example, inorganic hollow fillers such as glass balloon and the like and organic hollow fillers comprising polyvinylidene fluoride, polyvinylidene fluoride copolymers and the like, whereby a reduction in the weight can be achieved. Also, various foaming agents can be mixed in order to improve various physical properties such as a reduction in the weight, and gas can be mixed mechanically in mixing.

Further, capable of being used in combination as other additives are, if necessary, photosensitizers, heat polymerization inhibitors, curing accelerators, flame retardants, fungicides, hindered amine base light stabilizers, UV absorbers, antioxidants, colorants, coumarone resins, coumarone-indene resins, phenol terpene resins, petroleum base hydrocarbons, various tackifiers such as rosin derivatives and the like, various adhesive elastomers such as Leostomer B (trade name, manufactured by Riken Vinyl Industry Co., Ltd.) and the like, other thermoplastic elastomers or resins such as Hybrar (trade name, manufactured by Kuraray Co., Ltd., a block copolymer in which polystyrene blocks are connected to both ends of a vinyl-polyisoprene block), Nolex (trade name, manufactured by Zeon Corporation, polynorbornene obtained by subjecting norbornene to ring-opening polymerization) and the like.

### Gasket for Hard Disk Device:

The gasket of the present invention for a hard disk device comprises a cured matter obtained by curing the gasket-forming material of the present invention described above by irradiating with a UV ray, and it can be obtained, for example, by the following processes:
(1) a process in which the gasket is produced by extruding the gasket-forming material of the present invention from an extruding port of a three-dimensional automatic coating controlling apparatus to form an uncured gasket of a first stage, then further extruding, if necessary, the gasket-forming material on the above uncured gasket of a first stage to form an uncured gasket of a two stage structure and subsequently curing it by irradiating with an energy ray and
(2) a process in which the gasket is produced by extruding a gasket-forming material having an excellent adhesive property with a cover plate (hereinafter referred to as the adhesive gasket-forming material) other than the gasket-forming material of the present invention from an extruding port of a three-dimensional automatic coating controlling apparatus to form an uncured gasket of a first stage, curing it by irradiating with an energy ray, then further extruding the gasket-forming material of the present invention on the above uncured gasket of a first stage in the same manner from the extruding port of the three-dimensional automatic coating controlling apparatus to form an uncured gasket of a second stage and subsequently curing it by irradiating with an energy ray.

In forming the gasket on the base plate in the process of (2) described above, the gasket of a second stage may be formed by the gasket-forming material of the present invention on the gasket of a first stage formed on the base plate by using the gasket-forming material having an excellent adhesive property other than the gasket-forming material of the present invention.

A gasket having a narrow line width and a large height can be obtained by providing the gasket with a multistage structure. The multistage structure shall not be restricted to a two stage structure and may be a three or higher stage structure. When the gasket-forming material is different in the multistage structure, the gasket-forming material of the present invention has to be used for the gasket at a part requiring a low tacky property in the present invention from the viewpoint of a reworking property of the cover plate and the base plate.

The component (A) in the gasket-forming material of the present invention and (E) a nitrogen-containing heterocyclic structure-containing (meth)acryl base monomer represented by the following Formula (IV):

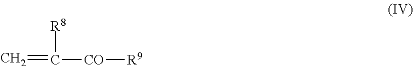

(wherein R⁸ is a hydrogen atom or methyl group, and R⁹ is a group having a nitrogen-containing heterocyclic structure) are preferably contained as the adhesive gasket-forming material described above. Containing of the above component (E) enhances an adhesive property between the cover plate and the gasket, improves the performances of the gasket and provides the good moldability. The component (E) shall be explained below.
Nitrogen-Containing Heterocyclic Structure-Containing (meth)acryl Base Monomer (E):

In Formula (IV), R⁸ is a hydrogen atom or methyl, and R⁹ is a group having a nitrogen-containing heterocyclic structure. This group having a nitrogen-containing heterocyclic structure shall not specifically be restricted, and it is preferably selected so that a cured matter of the above (meth)acryl base monomer itself has a glass transition temperature (Tg) falling in a range described later. For example, a morpholino group, a hexahydrophthalimide-N-ylethyloxy group and the like can be given as the above group.

In the nitrogen-containing heterocyclic structure-containing (meth)acryl base monomer of the above component (E), a glass transition temperature (Tg) of a cured matter thereof falls in a range of preferably 50 to 150° C., more preferably 100 to 150° C. from the viewpoint that the gasket which is excellent in an adhesive property between the cover plate and the base plate, performances and a moldability is obtained.

Monomers which provide cured matters having a glass transition temperature (Tg) falling in the range described above are preferably used as the nitrogen-containing heterocyclic structure-containing (meth)acryl base monomer of the above component (E), and capable of being suitably used is, for example, N-(acryloyl)morpholine (Tg: 145° C.) represented by the following Formula (IV-a), N-(acryloyloxyethyl)-hexahydrophthalimide (Tg: 56° C.) represented by Formula (IV-b), N-(acryloyloxyethyl)-1,2,3,6-tetrahydrophthalimide (Tg: 47° C.) represented by Formula (IV-c) or N-(acryloyloxyethyl)-3,4,5,6-tetrahydrophthalimide (Tg: 33° C.) represented by Formula (IV-d):

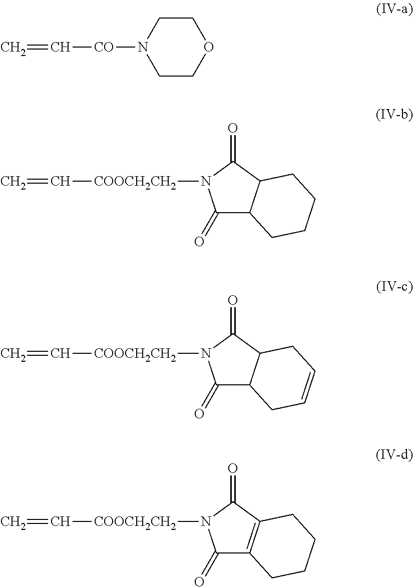

In the present invention, the nitrogen-containing heterocyclic structure-containing (meth)acryl base monomer may be used as the component (E) alone or in combination of two or more kinds thereof.

In the gasket-forming material of the present invention, a content of the nitrogen-containing heterocyclic structure-containing (meth)acryl base monomer of the above component (E) is preferably 5 to 40 parts by mass, more preferably 5 to 30 parts by mass based on 100 parts by mass of the energy ray-curable urethane liquid oligomer of the component (A) from the viewpoints that the gasket obtained improves a adhesive property of the cover plate and the base plate in the hard disk device and the viewpoint of performances and a moldability of the gasket.

An apparatus used for extruding the gasket material shall not specifically be restricted as long as it is an apparatus by which the gasket having a desired form can be formed on the cover plate or the base plate, and it includes a pneumatic extruding apparatus, a mechanical ram press extruding apparatus, a plunger type extruding apparatus and the like. The nozzle form shall not specifically be restricted and includes a circular form, an elliptical form, a polygonal form and the like. Also, an inner diameter of the nozzle can suitably be selected according to a width of the gasket and falls usually in a range of 0.1 to 1.2 mm.

An extruding pressure of the gasket-forming material is suitably selected according to the kind of the gasket-forming material and a viscosity thereof and the like, and it is preferably 50 kPa to 1 MPa. The pressure falling in the above range makes it possible to efficiently extrude the gasket-forming material and prevents an uncured gasket from being crushed, and the gasket having a sufficiently narrow line width and a sufficiently large height is obtained. From the above viewpoints, an extruding pressure of the gasket falls in a range of more preferably 80 kPa to 800 kPa, further preferably 100 kPa to 800 kPa and particularly preferably 200 kPa to 800 kPa.

A molding temperature of the gasket is suitably selected according to the gasket material used and falls in a range of preferably 0 to 100° C., more preferably 30 to 70° C.

A viscosity of the gasket-forming material shall not specifically be restricted as long as the gasket-forming material can be coated, and the viscosity at 50° C. falls usually in a range of preferably 50 to 1000 Pa·s. If the viscosity at 50° C. falls in the above range, the fluidity is suited, and therefore a shape of the gasket is liable to be formed.

An energy ray used for curing the uncured gasket includes a UV ray, an electron beam, an α ray, a β ray and a γ ray, and among them, a UV ray is particularly preferred in the present invention. A UV ray is simple in an equipment and easy to use and can cure well the uncured gasket.

When a UV ray is used, a photopolymerization initiator and/or a photosensitizer are preferably added to the gasket-forming material. On the other hand, when an electron beam and a y ray are used, curing can quickly be promoted without adding a photopolymerization initiator and a photosensitizer.

A xenon lamp, a low pressure mercury lamp, a high pressure mercury lamp, an ultrahigh pressure mercury lamp and the like can be given as the UV ray source. Atmosphere in which a UV ray is irradiated is preferably inert gas atmosphere of nitrogen gas, carbon dioxide gas and the like or atmosphere in which an oxygen concentration is reduced, and curing can be carried out with a UV ray even in usual aerial atmosphere. The irradiation atmospheric temperature can be usually 10 to 200° C. Further, baking can be carried out after curing to remove volatile components. In this case, the baking temperature is preferably 100 to 160° C.

### Cover Plate and Base Plate:

The cover plate or the base plate integrated with the gasket obtained by extruding and curing the gasket-forming material can be formed from metals and synthetic resins such as thermoplastic resins and the like. Metals suitably selected from, for example, nickel-plated aluminum, nickel-plated steel, cold rolled steel, zinc-plated steel, aluminum/zinc alloy-plated steel, stainless steel, aluminum, aluminum alloys, magnesium, magnesium alloys and the like can be used as the metals forming the cover plate and the base plate.

Further, those obtained by injection-molding magnesium can be used as well. Metals subjected to electroless nickel plating treatment are suited in terms of a corrosion resistance, and nickel-plated aluminum and nickel-plated steel are preferred in the present invention.

Publicly known methods which have so far been applied to metal materials, for example, a method in which metal plates are dipped in an electroless nickel plating bath comprising an aqueous solution containing nickel sulfate, sodium hypophosphite, lactic acid, propionic acid and the like in a suitable proportion and having a pH of 4.0 to 5.0 and a temperature of 85 to 95° C. can be used as an electroless nickel plating treating method.

The thermoplastic resins forming the cover plate and the base plate include, for example, thermoplastic resins including styrene base resins such as acrylonitrile styrene (AS) resins, acrylonitrile butadiene styrene (ABS) resins, polystyrene, syndiotactic polystyrene and the like, olefin base resins such as polyethylene, polypropylene, propylene complexes of ethylene-propylene copolymers and the like, polyamide base resins such as nylon and the like, polyester base resins such as polyethylene terephthalate, polybutylene terephthalate and the like, modified polyphenylene ether, acryl base resins, polyacetal, polycarbonate, liquid crystal polymers, polyphenylene sulfide (PPS) and the like, and they can suitably be selected from the above resins. Thermotropic liquid crystal polymers are preferred as the liquid crystal polymers, and they include, to be specific, polycarbonate base liquid crystal polymers, polyurethane base liquid crystal polymers, polyamide base liquid crystal polymers, polyester base liquid crystal polymers and the like. The above resins may be used alone or in combination of two or more kinds thereof.

In order to enhance an adhesive property of the cover plate or the base plate with the gasket, the cover member can be subjected in advance to surface treatment when the cover plate or the base plate is made of a synthetic resin. The surface treatment includes plasma treatment, corona discharge treatment and the like. An equipment such as a plasma irradiator manufactured by Keyence Corporation can be used for the plasma treatment.

Further, an adhesive property of the cover plate or the base plate with the gasket can be enhanced by subjecting the cover plate or the base plate to such primer treatment that an adhesion improving agent is coated on the cover plate or the base plate in accordance with the form of the gasket and then extruding the gasket-forming material thereon.

### EXAMPLES

Next, the present invention shall be explained in further details with reference to examples, but the present invention shall by no means be restricted by these examples.

Evaluations in the following examples and comparative examples were carried out by the following methods.

### (1) Physical Properties of Cured Matter:

A film of the gasket-forming material was produced in a thickness of 0.6 mm on a glass plate, and this was irradiated with an energy ray to obtain a cured sheet. A metal halide lamp was used for the energy ray, and it was radiated on the conditions of an illuminance of about 150 mW/cm² and an integrated light quantity of about 9000 mJ/cm² under aerial atmosphere. The above cured sheet was further subjected to baking treatment at 120° C. for 4 hours under aerial atmosphere.

### (a) Tack (Surface Tacky Property):

A cylindrical probe made of SUS304 was pressed onto a surface of the cured sheet obtained above having a thickness of 0.6 mm on a fixed condition, and a force required when it was pulled up was measured. A measured surface of the sheet is a surface which turned toward an aerial side in curing with a UV ray.

### Measuring Conditions:

Measuring environment: 25° C.

Probe diameter: φ5.0 mm

Pressing speed: 120 mm/minute

Pressing load: 3 seconds at 30 gf

Pulling-up speed: 600 mm/minute

### (b) Compressed Surface Pressure:

Two sheets of the cured sheet obtained above having a thickness of 0.6 mm were superposed in a thickness of 1.2 mm, and pressure was applied thereon to measure a compressing force (surface pressure) observed when a compression rate was set to 20%. A load-deflection test equipment (MODEL 1605N, manufactured by Aikoh Engineering Co., Ltd.) was used to measure the compressing force, and a circular tip of 2 mmφ was used as a tip of a jig for applying pressure.

### (c) Moisture Permeability:

A moisture permeability of the cured sheet obtained above having a thickness of 0.6 mm was measured on the conditions of 40° C. and a relative humidity of 90% according to JIS 20208 using a moisture permeable cup of an A method described in JIS L1099.

### (d) Hardness:

A hardness of the cured sheet obtained above was measured according to JIS K6253-1993 by means of a type A durometer. A matter having a thickness of about 6 mm obtained by laminating 10 sheets of the sheet having a thickness of about 0.6 mm was used for the test subject.

### (2) Reworking Property of Cover Plate in HDD:

The cover plate on which the gasket was formed was mounted on the base plate and left standing at 85° C. for 24 hours, and then the cover plate was detached to visually confirm the presence of breaking and peeling of the gasket. The test described above was repeated five times to confirm finally right and wrong of the reworking property.

### Production Example 1

### Production of Energy Ray-Curable Urethane Liquid Oligomer

A four neck flask of 1 liter equipped with a stirrer, a cooling tube and a thermometer was charged with 400 g of a polyesterdiol compound (number average molecular weight: 2000) obtained from 2,4-diethyl-1,5-pentanediol and phthalic anhydride, 82.4 g of norbornanediisocyanate and 0.10 g of 2,6-di-t-butyl-4-methylphenol which was an antioxidant to react them at 80° C. for 2 hours. Then, 46.2 g of 2-hydroxyethyl acrylate, 0.10 g of p-methoxyphenol which was a polymerization inhibitor and 0.06 g of titanium tetra(2-ethyl-1-hexanoate) which was an addition reaction catalyst were added thereto to react them at 85° C. for 6 hours. A part of the reaction liquid was taken out to confirm an end point of the reaction by disappearance of an absorption peak of an isocyanate group at 2280 cm⁻¹ in an infrared absorption spectrum to thereby obtain a urethane oligomer. A number average molecular weight of the urethane oligomer thus obtained was determined in terms of a polystyrene-reduced value by using a gel permeation chromatography to find that it was 18000.

### Examples 1 to 13 and Comparative Examples 1 to 3

Gasket-forming materials having compositions shown in Table 1 were prepared, and the physical properties of cured matters of the respective materials were determined. Further, a reworking property of the cover plate in HDD was evaluated. The material prepared only from the urethane oligomer in which the monomer was not blended is shown in Table 1 for the sake of reference.

TABLE 1-1

| | | | Example | | | | | | | |
|---|---|---|---|---|---|---|---|---|---|---|
| | | | 1 | 2 | 3 | 4 | 5 | 6 | 7 | 8 |
| Composition | Urethane oligomer¹⁾ | | 100 | 100 | 100 | 100 | 100 | 100 | 100 | 100 |
| of gasket- | (mass part) | | | | | | | | | |
| forming | Acryl base | Kind²⁾ | A | A | A | A | B | C | D | B |
| material | monomer | Amount | 5 | 10 | 20 | 40 | 10 | 10 | 10 | 10 |
| | | (mass part) | | | | | | | | |
| | Additives | Thickener³⁾ | 3.2 | 3.2 | 3.2 | 3.2 | 3.2 | 3.2 | 3.2 | 3.2 |
| | (mass part) | Toner⁴⁾ | 0.75 | 0.75 | 0.75 | 0.75 | 0.75 | 0.75 | 0.75 | 0.75 |
| | | Additive⁵⁾ | 1 | 1 | 1 | 1 | 1 | 1 | 1 | 1 |
| | | Photo- | 2 | 2 | 2 | 2 | 2 | 2 | 2 | 2 |
| | | polymerization | | | | | | | | |
| | | initiator⁶⁾ | | | | | | | | |
| Evaluation | Physical | Tack (gf) | 309.4 | 320.3 | 378.3 | 487.7 | 374.9 | 313.7 | 322.5 | 387.2 |
| | properties | Compressed | 3.5 | 3.5 | 3.0 | 2.8 | 3.0 | 3.3 | 3.2 | 3.0 |
| | of cured | surface | | | | | | | | |
| | matter | pressure (N) | | | | | | | | |
| | | Moisture | 18.2 | 19.0 | 17.1 | 15.2 | 22.5 | 22.4 | 22.5 | 25.8 |
| | | permeability | | | | | | | | |
| | | (g/24 h · m²) | | | | | | | | |
| | | Hardness | 36.1 | 34.6 | 33.5 | 31.3 | 33.7 | 35.1 | 34.4 | 34.4 |
| | | (grade) | | | | | | | | |
| | Reworking | 1.8 inch | No | No | No | No | No | No | No | No |
| | property of | | peeling | peeling | peeling | peeling | peeling | peeling | peeling | peeling |
| | HDD top | 2.5 inch | No | No | No | No | No | No | No | No |
| | cover | | peeling | peeling | peeling | peeling | peeling | peeling | peeling | peeling |

TABLE 1-2

| | | | Example | | | | | Comparative Example | | | Reference |
|---|---|---|---|---|---|---|---|---|---|---|---|
| | | | 9 | 10 | 11 | 12 | 13 | 1 | 2 | 3 | Example 1 |
| Composition | Urethane oligomer¹⁾ | | 100 | 100 | 100 | 100 | 100 | 100 | 100 | 100 | 100 |
| of gasket- | (mass part) | | | | | | | | | | |
| forming | Acryl base | Kind²⁾ | F | G | H | A | A | I | J | K | — |
| material | monomer | Amount | 10 | 10 | 10 | 2 | 50 | 10 | 10 | 10 | — |
| | | (mass part) | | | | | | | | | |
| | Additives | Thickener³⁾ | 3.2 | 3.2 | 3.2 | 3.2 | 3.2 | 3.2 | 3.2 | 3.2 | 3.2 |
| | (mass part) | Toner⁴⁾ | 0.75 | 0.75 | 0.75 | 0.75 | 0.75 | 0.75 | 0.75 | 0.75 | 0.75 |
| | | Additive⁵⁾ | 1 | 1 | 1 | 1 | 1 | 1 | 1 | 1 | 1 |
| | | Photo- | 2 | 2 | 2 | 2 | 2 | 2 | 2 | 2 | 2 |
| | | Polymerization | | | | | | | | | |
| | | initiator⁶⁾ | | | | | | | | | |
| Evaluation | Physical | Tack (gf) | 321.0 | 374.8 | 342.3 | 349.6 | 518.6 | 418.7 | 131.6 | 284.2 | 439.7 |
| | properties | Compressed | 2.8 | 2.8 | 3.5 | 3.7 | 2.7 | 4.9 | 14.0 | 5.2 | 3.8 |
| | of cured | surface | | | | | | | | | |
| | matter | pressure (N) | | | | | | | | | |
| | | Moisture | 21.9 | 20.2 | 35.2 | 19.7 | 13.7 | 16.2 | 18.9 | 29.3 | 20.3 |
| | | permeability | | | | | | | | | |
| | | (g/24 h · m²) | | | | | | | | | |
| | | Hardness | 32.8 | 32.8 | 34.6 | 35.6 | 29.9 | 36.2 | 58.2 | 48.3 | 36.4 |
| | | (grade) | | | | | | | | | |
| | Reworking | 1.8 inch | No | No | No | No | No | peeling | peeling | peeling | peeling |
| | property | | peeling | peeling | peeling | peeling | peeling | | | | |
| | of HDD top | 2.5 inch | No | No | No | No | No | peeling | peeling | peeling | peeling |
| | cover | | peeling | peeling | peeling | peeling | peeling | | | | |

### Remarks:

1) Urethane oligomer obtained in Production Example 1
2) A: nonylphenol EO-modified acrylate (n=1), trade name: M-111, manufactured by Toagosei Co., Ltd., structural formula (III-a), Tg=17° C.
B: nonylphenol EO-modified acrylate (n=4), trade name: NP-4EA, manufactured by Kyoeisha Chemical Co., Ltd., structural formula (III-b), Tg=−20° C.
C: phenol EO-modified acrylate (n=2), trade name: M-101A, manufactured by Toagosei. Co., Ltd., structural formula (III-d), Tg=−8° C.
C: phenol EO-modified acrylate (n=2), trade name: P-200A, manufactured by Kyoeisha Chemical Co., Ltd., structural formula (III-d), Tg=−25° C.
E: phenol EO-modified acrylate (n=4), trade name: M-102, manufactured by Toagosei Co., Ltd., structural formula (III-e), Tg=−18° C.
F: lauryl acrylate, trade name: L-A, manufactured by Kyoeisha Chemical Co., Ltd., Tg=−3° C.
G: isomyristyl acrylate, trade name: IM-A, manufactured by Kyoeisha Chemical Co., Ltd., Tg=−56° C.
H: ethylcarbitol acrylate, trade name: Viscoat #190, manufactured by Osaka Organic Chemical Industry Ltd., Tg=−67° C.
I: isobornyl acrylate, trade name: IBXA, manufactured by Osaka Organic Chemical Industry Ltd., Tg=94° C.
J: N-(acryloyl)morpholine, trade name: ACMO, manufactured by KOHJIN Co., Ltd., Tg=145° C.
K: polyethylene glycol diacrylate, trade name: M-243, manufactured by Toagosei Co., Ltd., Tg=12° C.
3) Thickener: hydrogenated castor oil, trade name: ADVITROL 100, manufactured by Süd-Chemie Catalysts Japan. Inc.
4) Toner: trade name: CMB-B1, manufactured by Nippon Pigment Co., Ltd.
5) Additive: trade name: Elastostab H01, manufactured by Nisshinboseki Co., Ltd.
6) Photopolymerization initiator: trade name: Irgacure 2959, manufactured by Ciba Specialty Chemicals K.K.

As can be seen from the results shown in Table 1, the physical properties of the cured matters produced from the gasket-forming materials in Examples 1 to 3 and 5 to 11 are excellent in a balance between the tack, the compressed surface pressure, the moisture permeability and the hardness in all cases, and a reworking property of the cover plate and the base plate in HDD is good. Since a blending amount of the (meth)acrylate base monomer is large in Example 4 and Example 13, the tack is deteriorated, and since a blending amount of the (meth)acrylate base monomer is too small in Example 12, the compressed surface pressure grows high.

In Comparative Examples 1 to 3, the compressed surface pressures are higher in all cases than in the examples.

### Reference Example 1

Prepared was a gasket-forming material comprising 100 pars by mass of the urethane oligomer obtained in Production Example 1, 7 pars by mass of N-(acryloyl)morpholine, 3 pars by mass of the thickener ADVITROL 100 (described above), 1 part by mass of the toner CMB-B1 (described above), 1 part by mass of the additive Elastostab H01 (described above) and 2 parts by mass of the photopolymerization initiator Irgacure 2959 (described above).

### Example 14

The gasket-forming material obtained in Reference Example 1 was used to form an uncured gasket of a first stage on a SUS304-made plate (cover plate) having a thickness of 0.4 mm plated with nickel in a 1.8 inch HDD and an aluminum plate (cover plate) having a thickness of 0.4 mm plated with nickel in a 2.5 inch HDD by means of a three-dimensional automatic coating controlling apparatus, and this was cured by irradiating with a UV ray by means of a UV ray irradiation equipment. The gasket-forming material used in Example 6 was extruded on the above gasket of a first stage by means of the above apparatus to form an uncured gasket of a second stage, and then it was cured by further irradiating with a UV ray by means of the UV ray irradiation equipment. The conditions of irradiation with a UV ray were an illuminance of 150 mW/cm² and an integrated light quantity of 9000 mJ/cm² in both cases, and a ratio (h/w) of a height (h) to a width (w) of the gasket obtained above was 1.1.

A dispenser apparatus was used as the three-dimensional automatic coating controlling apparatus. The above apparatus can be used in the forms of a screw type and a pneumatic type, and it was used in the form of a pneumatic extruding apparatus in the present example. An extruding port of the above extruding apparatus can be exchanged, and the form of the extruding port was circular. The apparatus having a nozzle inner diameter of 0.72 mm was used to carry out the extrusion.

Further, UV1501BA-LT manufactured by Sen Engineering Co., Ltd. was used as the UV ray irradiation equipment.

The gasket of a two stage structure thus prepared was evaluated for a reworking property of the HDD cover plate. In detaching the cover plate from the base plate, breaking and peeling of the gasket were not observed in both of 1.8 inch HDD and 2.5 inch HDD, and it had a small resistance and a good workability and showed a good reworking property.

### INDUSTRIAL APPLICABILITY

The gasket-forming material of the present invention can provide a gasket improved in a reworking property of a cover plate and a base plate in HDD.

1. A gasket-forming material for a hard disk device comprising (A) an energy ray-curable urethane liquid oligomer having a polymerizable unsaturated group and (B) a monofunctional (meth)acryl base monomer providing a cured matter having a glass transition temperature (Tg) of −70 to 20° C.

2. The gasket-forming material for a hard disk device according to claim 1, wherein (A) the energy ray-curable urethane liquid oligomer having a polymerizable unsaturated group is an unsaturated group-containing urethane oligomer represented by the following Formula (I):
R¹—O—CONH—R²—NHCO—(—O—R³—O—CONH—R²—NHCO)ₚ-(-A-CONH—R²—NHCO—)_{q}—(—O—R³—O—CONH—R²—NHCO—)ᵣ—O—R¹ (I)
(wherein R¹ is a hydroxyl group-removed residue of a monool compound containing at least any unsaturated group of a (meth)acryloyl group and a vinyl group; R² is an isocyanate-removed residue of an organic diisocyanate compound; R³ is a hydroxyl group-removed residue of a polyesterdiol compound having a number average molecular weight of 1×10³ to 1×10⁴ and containing a cyclic group or a branched chain group; A is a dehydrogenated residue of a diamine compound or a dehydrogenated residue of a diol compound; each of p and r is 0 to 7, and q is 0 to 3, provided that when q is 0, 1≦p+r≦10) and having a number average molecular weight of 5×10³ to 5×10⁴.

3. The gasket-forming material for a hard disk device according to claim 2, wherein R³ in Formula (I) is a hydroxyl group-removed residue of a polyesterdiol compound obtained by condensing cyclic group-containing dicarboxylic acid with diol or a hydroxyl group-removed residue of a polyesterdiol compound modified by reacting cyclic group-containing dicarboxylic anhydride with diol.

4. The gasket-forming material for a hard disk device according to claim 2, wherein R¹ in Formula (I) is a hydroxyl group-removed residue of a monool compound of any of hydroxyalkyl (meth)acrylate and hydroxyalkyl vinyl ether.

5. The gasket-forming material for a hard disk device according to claim 2, wherein the unsaturated group-containing urethane oligomer (a case in which q is 0 in Formula (I)) is obtained by subjecting a polyesterdiol compound and an organic isocyanate compound to polyaddition reaction to form an addition product having isocyanate groups at both ends and then adding monool compounds to the above isocyanate groups.

6. The gasket-forming material for a hard disk device according to claim 2, wherein the unsaturated group-containing urethane oligomer (a case in which q is not 0 in Formula (I)) is obtained by subjecting a polyesterdiol compound and an organic isocyanate compound to polyaddition reaction to form an addition product having isocyanate groups at both ends and then adding each end of a diamine compound or a diol compound to an isocyanate group of the above addition product at one end and adding a monool compound to an isocyanate group of the above addition product at the other one end.

7. The gasket-forming material for a hard disk device according to claim 1, wherein (B) the monofunctional (meth)acryl base monomer providing a cured matter having a glass transition temperature (Tg) of −70 to 20° C. is a (meth)acrylic ester compound represented by Formula (II): 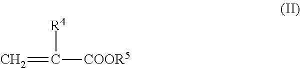
(wherein R⁴ represents a hydrogen atom or methyl group, and R⁵ represents an alkyl group having 8 to 20 carbon atoms).

8. The gasket-forming material for a hard disk device according to claim 1, wherein (B) the monofunctional (meth)acryl base monomer (B) providing a cured matter having a glass transition temperature (Tg) of −70 to 20° C. is a (meth)acrylic ester compound represented by Formula (III): 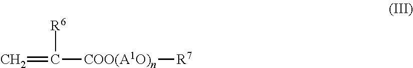
(wherein A¹ represents an alkylene group having 2 to 4 carbon atoms; R⁶ represents a hydrogen atom or methyl group; R⁷ represents an alkyl group having 6 to 20 carbon atoms, an aralkyl group having 7 to 20 carbon atoms or an aryl group having 6 to 20 carbon atoms; and n represents 1 to 7 on an average).

9. The gasket-forming material for a hard disk device according to claim 1, comprising 5 to 40 parts by mass of the component (B) based on 100 parts by mass of the component (A).

10. The gasket-forming material for a hard disk device according to claim 1, further comprising 0.5 to 10 parts by mass of (C) a thixotropicity-providing agent based on 100 parts by mass of the component (A).

11. The gasket-forming material for a hard disk device according to claim 10, wherein the component (C) is an organic thickener.

12. The gasket-forming material for a hard disk device according to claim 11, wherein the organic thickener is hydrogenated castor oil.

13. The gasket-forming material for a hard disk device according to claim 1, further comprising at least one of a polymerization initiator and a cross-linking agent as a component (D).

14. A gasket for a hard disk device comprising a cured matter prepared by curing the gasket-forming material according to claim 1 by irradiating with an energy ray.
